(19) United States
(12) Patent Application Publication
(10) Pub. No.: US 2026/0051208 A1
(43) Pub. Date: Feb. 19, 2026

(54) METHOD FOR IDENTIFYING AN ANOMALY IN A COMPONENT OF A TECHNICAL SYSTEM

(71) Applicant: Robert Bosch GmbH, Stuttgart (DE)

(72) Inventors: Gabriella Kokai, Wien (AT); Hannes Hitzer, Horb Am Neckar (DE); Dierk Staebler, Oberriexingen (DE)

(21) Appl. No.: 19/217,432

(22) Filed: May 23, 2025

(30) Foreign Application Priority Data
May 29, 2024 (DE) 10 2024 205 022.9

(51) Int. Cl. G07C 5/08; F02B 39/16; H04R 1/02

(52) U.S. Cl. CPC G07C 5/0833; F02B 39/16; H04R 1/028; H04R 2499/13

(57) ABSTRACT

A method for identifying an anomaly in a component of a technical system, the component performing a periodic movement during operation of the technical system. The method includes: providing a sound signal detected using a sensor during operation of the technical system; determining or providing a rotational speed range in which a rotational speed of the component lies during operation of the technical system; determining or providing operating point range(s) of the technical system in which the anomaly is to be expected; determining a filtered sound signal from the sound signal and based on the rotational speed range and the operating point range(s); determining a measure of a tone stability of the filtered sound signal; and determining, based on the measure of the tone stability, whether an anomaly of the component is present and/or to what extent the anomaly of the component is present.

### FIELD

The present invention relates to methods for identifying an anomaly in a component of a technical system, wherein the component performs a rotational movement during operation of the technical system, and to a computing unit and a computer program for performing the method.

### BACKGROUND INFORMATION

A turbocharger, also called exhaust turbocharger (ATL) or colloquially turbo, is used to increase the performance or efficiency of internal combustion engines. As the operating time increases, an anomaly, such as a defect, of a turbine wheel or compressor wheel of the exhaust turbocharger may occur. An engine with a turbocharger is described in U.S. Pat. No. 6,796,289 B1; a method for collecting sensor data is described in EP Patent Application No. EP 3 652 721 A1. PCT Patent Application No. WO 2021/003551 A1 relates to a turbine.

### SUMMARY

According to the present invention, a method for identifying an anomaly in a component of a technical system as well as a computing unit and a computer program for performing the method are provided. Advantageous example embodiments of the present invention are disclosed herein.

The present invention relates to components of a technical system that perform a rotational movement during operation of the technical system, such as the turbine wheel or compressor wheel of an exhaust turbocharger of, for example, combustion engines.

Exhaust turbochargers (ATL) are auxiliary units in combustion engines and are used there to compress the supplied air. Due to the higher mass air flow and thus the greater amount of oxygen, the combustion engines can be operated more efficiently, i.e., the engine power increases. In a simple form, the turbocharger has a turbine wheel, which is driven by the energy of the exhaust gases, and a compressor wheel, which uses the drive energy to increase the air pressure in the intake system. The turbine wheel and compressor wheel are typically non-rotatably fixed to a shaft and are mounted in a hydrodynamic plain bearing in a housing.

Further component parts of the turbocharger are, for example, an intercooler as well as a wastegate device, which is used to regulate the boost pressure and to protect the ATL from overload. In addition to the turbochargers mentioned, there are also other types, e.g., turbochargers with variable turbine geometry (VTG).

The turbine wheel or compressor wheel of an exhaust turbocharger may be damaged over the operating life. Identifying such damage is difficult, especially since there are generally no sensors that could be used directly here.

In light of this, it is provided according to the present invention to use a sound signal, e.g., from a structure-borne sound sensor such as a so-called knock sensor, as a basis. This is because knock sensors that sense the structure-borne sound of the engine block are, for example, installed in conventional gasoline engines. Their function typically consists of detecting signals and forwarding them to the engine control unit (ECU). If ignition of the air-fuel mixture takes place prematurely, this leads to undesirable knocking of the engine (the combustion engine), with the risk of damage to engine components. On the other hand, if ignition occurs too late, this leads to suboptimal energy yield. The current aim of existing signal detection by means of the knock sensor is therefore to avoid engine knocking in order to reduce fuel consumption on the one hand and to increase engine torque on the other hand. This ensures the best possible performance of the engine.

Since the knock sensor detects the characteristic structure-borne sound signature of the engine or the combustion engine and forwards it to the engine control unit, as described, the signal may also contain information that allows conclusions to be drawn not only about knocking but also further forms of force excitation. These may be excitations of other components, or changes caused by the operating behavior of the combustion engine. In addition, there is the possibility of ascertaining the state of health of a component, a subsystem, or a system. In the event of damage, the force excitation, which transmits through the structure and manifests as a surface vibration motion, can change due to an error pattern during ongoing operation. If this change in the excitation is measurable in the form of an acceleration on the engine surface, an indicator for the presence of a fault or for the state of health of the system considered can be ascertained by means of signal evaluation.

A method according to an example embodiment of the present invention is to be explained below in particular with reference to the example of the exhaust turbocharger, but the method may also be applied to other components of technical systems in which the components perform a rotational movement or another periodic movement during operation. In addition, it is possible to identify not only damage explicitly but also anomalies in general.

As mentioned, a sound signal is provided, which has been detected by means of a sensor of the technical system (e.g., the exhaust turbocharger) or of a further technical system (e.g., the combustion engine or a cylinder thereof) mechanically connected to the technical system, during operation of the technical system. The sensor may be arranged on the technical system. Suitable sensors are, as mentioned, a structure-borne sound sensor or knock sensor, but other types of sound can in general also be detected, with corresponding other sound sensors in this case.

In addition, a rotational speed range in which a rotational speed of the component lies during operation of the technical system is determined or provided. In principle, it is possible that a rotational speed sensor is used for this purpose. However, often times, such as with a typical exhaust turbocharger, there is no rotational speed sensor present. In one embodiment, operating variable information on one or more operating variables of the technical system can be provided during operation of the technical system. The rotational speed range is then determined based on the operating variable information. In the case of the exhaust turbocharger, thermodynamic operating variables such as mass air flow and pressure ratio are suitable, for example.

In this case, reference is also made to so-called virtual sensors. The rotational speeds can be determined on the basis of sound signals, in particular airborne sound signals or structure-borne sound signals, wherein a spectral analysis is performed. More details in this respect are discussed below.

In addition, one or more operating point ranges of the technical system in which the anomaly is to be expected are determined or provided. This is because, as has been shown, anomalies or their effects in the sound signal particularly occur at only a few operating points but not continuously at all possible operating points. In one embodiment, signal information can be provided via one or more signals, e.g., control unit signals, present during operation of the technical system.

The one or more operating point ranges of the technical system in which the anomaly is to be expected are then determined based on the signal information. Suitable signals of this type are, for example, a corrected mass flow, a relative fuel mass, an actual torque without anti-jerk intervention minus an internal moment, a vehicle velocity, as well as an upper-limited reference level. These signals allow very precise conclusions to be drawn about the specific operating points.

From the sound signal and based on the rotational speed range and the one or more operating point ranges, a filtered sound signal is then determined. This filtered sound signal then specifically comprises the signals caused by the anomaly, provided that there is an anomaly.

A measure of a tone stability of the filtered sound signal is then determined. In one example embodiment of the present invention, the measure of the tone stability of the filtered sound signal is based on a complimentary value of a spectral flatness of the filtered sound signal that is aggregated into a density distribution or frequency distribution over multiple points in time.

The spectrum of a noise describes which frequency components are contained in the noise. Tonal and noise-like broadband noises can be distinguished. In the case of a tonal noise, one frequency dominates. It is therefore possible to assign a pitch. Simple examples are: whistle of a steam locomotive, propeller noise, pan flute. Broadband noises, on the other hand, do not have a dominant frequency. Often times, however, certain frequency ranges are more pronounced so that it is possible to assign a timbre. The transition region between noise and tone is referred to as tone stability from the perspective of noise and relates particularly to periodically operating machines.

Tone stability or timbre stability (also referred to as tonality where appropriate) of a noise is present if single tones can be heard within the noise. Tone stability generally significantly increases the possible interference effect of a noise. Methods for assessing the tone stability are generally defined, e.g., in the regulations ISO 1996-2, TA Lärm [Technical Instructions on Noise Protection], and DIN 45681. Single tones often occur in periodically operating machines; for example, when an exciting frequency is equal to or approximately equal to the natural frequency of a particular part and, as a result, increased sound radiation of this single frequency or of a narrow frequency band occurs due to a resonance phenomenon.

In order to quantify the tone stability in the filtered sound signal and to be able to automate the process of identification, the measure of spectral flatness (SF) has proven to be particularly suitable. The spectral flatness can be ascertained from the power spectrum. This measure represents the ratio between the geometric mean and the arithmetic mean and thus serves as an indicator of how tone-stable the signal is in the filtered sound signal (cf. also signal-to-noise ratio). Since, by definition, the spectral flatness assumes the value 1 in the case of pure noise and the value 0 in the case of pure tone stability, the complement is formed (1-SF) for reasons of interpretability (increasing damage, increasing value).

In order to make the method of the present invention for identifying anomalies or damages even more robust on the basis of the spectral flatness, the ascertained complementary values of the spectral flatness can be aggregated into a density distribution (or a frequency distribution) over multiple points in time (e.g., over a complete measurement cycle). This distribution describes how often tonal components occur in a particular time interval. If an unbalance occurs, tonal components accumulate and the indicator value increases, while noise is more likely to occur in the undamaged state, i.e., when no tonal components are present, and smaller indicator values are thus to be expected.

Based on the measure of the tone stability, it is then determined whether an anomaly of the component is present and/or to what extent the anomaly of the component is present. In one example embodiment of the present invention, a deviation between the measure of the tone stability of the filtered sound signal and a measure of the tone stability of a filtered comparison sound signal is determined for this purpose. Based on the deviation, it is then determined whether the anomaly of the component is present and/or to what extent the anomaly of the component is present. The deviation may, for example, be determined based on a so-called Kolmogorov-Smirnov test, by means of which different distributions can be particularly well compared. More details in this respect are discussed below.

In the specific example, the method of the present invention thus makes it possible to identify compressor blade damage on the exhaust turbocharger. The causes in the field for the damage pattern may, for example, be foreign object passage, and therefore breakage of the blade due to a collision with the foreign object, or surface removal due to erosion. Compressor blade damages generally result in an unbalance or in increasing tone stability in the airborne sound.

More generally, the method of the present invention allows for a technical solution on how increasing tonal components of rotating machine elements can be identified under variable operating conditions.

With the method according to the present invention, it is in particular possible to identify the damage in as early a state as possible. In short, the steps of ascertaining the rotational speed (by means of a virtual sensor where appropriate), operating point filtering (so-called visibility classifier) as well as extracting, aggregating and evaluating features in the portions marked as valid are provided for this purpose, wherein the individual steps as well as the method as a whole provide advantages.

The expected rotational speed of the turbocharger shaft can thus be ascertained by means of a compressor map on the basis of the ECU variables “pressure ratio via compressor” and “mass air flow via throttle valve.” This makes it possible to pre-filter the relevant frequency ranges of the signal (e.g., via the spectrograms) and thus to reduce the data to be processed, which in turn leads to the reduction of computing capacities and computing times. Furthermore, the rotational speed model can be used as a virtual sensor for determining the turbocharger rotational speed.

The pre-filtering of the ranges in which the rotational speed is to be expected is also possible with very noisy structure-borne sound data strongly superimposed by interference variables (e.g., combustor noises).

The method of the present invention can be based on the knock sensors present on the engine housing and thus does not require the additional installation of further sensors for damage identification.

A computing unit according to the present invention, e.g., a control unit of a motor vehicle or a computer, is configured, in particular in terms of program technology, to perform a method according to the present invention.

The implementation of a method according to the present invention in the form of a computer program or computer program product comprising program code for performing all method steps is advantageous as well, since the associated costs are very low, in particular if an executing control unit is also used for other tasks and is therefore already present. Lastly, a machine-readable storage medium is provided, on which the computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is also possible. Such downloading can be carried out in a wired, or cabled, or wireless manner (e.g., via a WLAN, a 3G, 4G, 5G, or 6G connection, etc.).

Further advantages and example embodiments of the present invention emerge from the description and the figures.

The present invention is shown schematically in the figures on the basis of exemplary embodiments and is described below with reference to the figures.

### BRIEF DESCRIPTION OF THE DRAWINGS

FIG. 1 schematically shows a technical system in which the present invention is usable.

FIG. 2 shows a sequence of a method of the present invention in one example embodiment.

FIGS. 3, 4, 5, 6A, 6B show diagrams for explaining the present invention.

### DETAILED DESCRIPTION OF EXAMPLE EMBODIMENTS

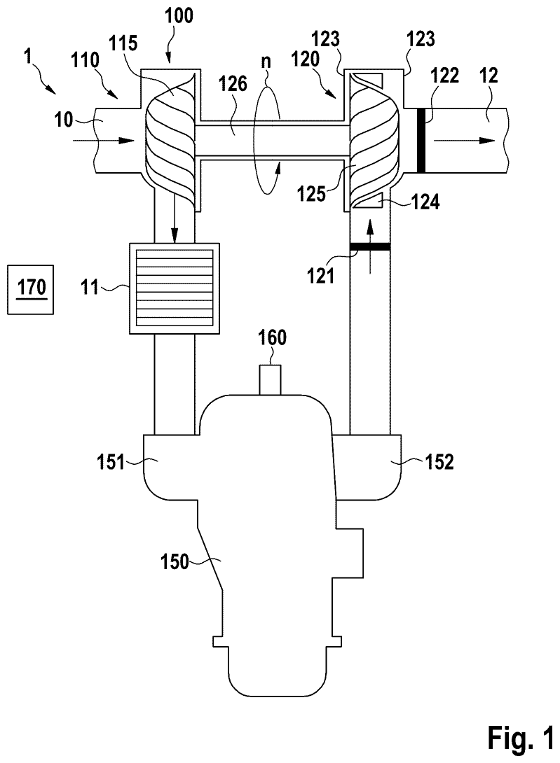

FIG. 1 schematically shows a technical system 100, which is designed as an exhaust turbocharger and in which the present invention is usable. A section of a combustion engine 1 with a cylinder or cylinder block 150 and the exhaust turbocharger 100 is shown schematically. The cylinder block 150 comprises an air inlet 151 for supplying fresh air and an exhaust manifold 152 for discharging exhaust gas.

The exhaust turbocharger 100 comprises a turbine 120 and a compressor 110 driven thereby. The compressor 110 is supplied with fresh air 10, compresses it to a boost pressure and supplies it to the cylinder block 150 via an optional air cooler 11. An air/fuel mixture is known to be combusted in the cylinder block 150, and the exhaust gas produced thereby is supplied to the turbine 120 via the exhaust manifold 152.

The turbine 120 comprises a turbine housing 123 with a turbine inlet 121 and a turbine outlet 122 as well as a guide vane apparatus 124 therebetween with adjustable guide vanes and a turbine wheel 125. The exhaust gas enters the turbine housing 123 under pressure at the turbine inlet and flows through the turbine housing 123 and the guide vane apparatus 124, wherein the pressure is throttled at the transition between the guide vane apparatus and the turbine wheel. The exhaust gas drives the turbine wheel 125 before it exits into an exhaust system 12 at the turbine outlet 122.

Here, the turbine wheel 125 is coupled to a compressor wheel 115 of the compressor 110 via a shaft 126. During operation, the turbine wheel 125 and the compressor wheel 115 rotate at a rotational speed denoted by n here.

The exhaust turbocharger shown here is only exemplary; for example, an exhaust turbocharger with wastegate could also be used.

Furthermore, a computing unit 170 designed as an engine control unit, and a structure-borne sound sensor or knock sensor 160, which is arranged on the cylinder block 150 by way of example.

As mentioned, in such an exhaust turbocharger, anomalies or damages can occur, e.g., on the compressor blades. Starting from the hypothesis that a mass removal on the compressor blade results in an unbalance in the running behavior of the turbocharger shaft, this can lead to a periodic excitation of the system. Periodic means that a stronger force impulse takes place per shaft revolution. This is followed by an increased energy input (in comparison to the undamaged state), which correlates with the rotational speed of the turbocharger shaft.

The identification of such anomalies is explained in more detail below.

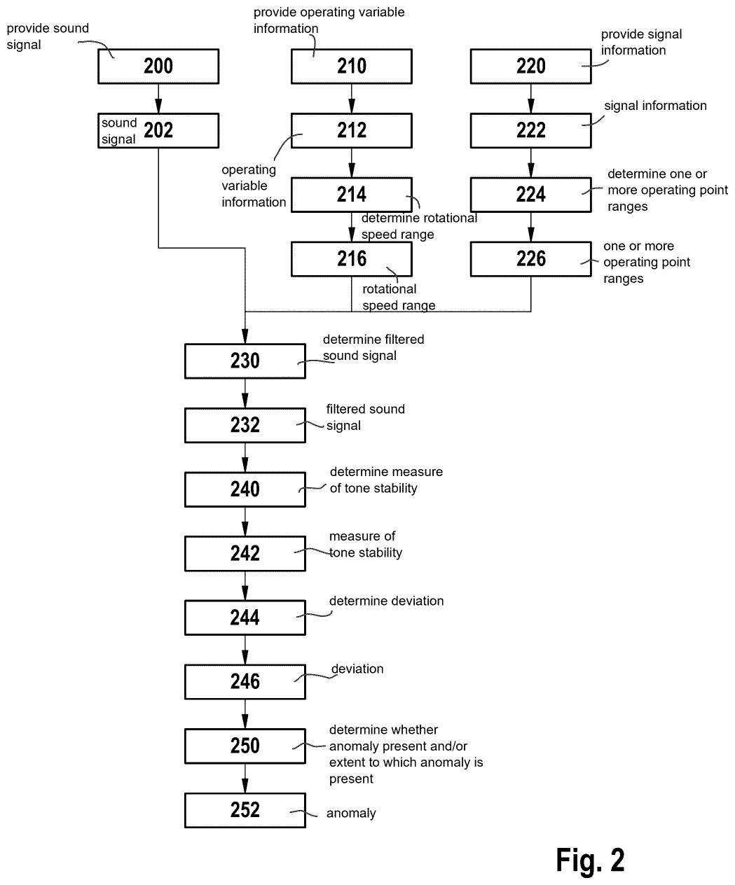

FIG. 2 schematically shows a sequence of a method according to the present invention in one example embodiment.

In a step 200, a sound signal 202 is provided, wherein the sound signal has been detected, for example, by means of the mentioned knock sensor during operation of the technical system, i.e., for example, of the exhaust turbocharger.

In step 210, operating variable information 212 on one or more operating variables, such as mass air flow and pressure ratio of the exhaust turbocharger is then provided during operation. In a step 214, a rotational speed range 216 in which a rotational speed of the component lies during operation of the exhaust turbocharger is determined based thereon.

Thus, in particular, data collection is carried out first. In the specific example, this comprises the detection of the knock sensor signal at the engine block and the detection of the relevant thermodynamic variables (operating variables), e.g., in the air system (e.g., pressure ratio via compressor as well as mass air flow via throttle valve). In particular, the variables are measured in a time-synchronous manner by a measurement computer during operation under load. For example, the knock sensor signal is sampled at 100 kHz, but other sampling rates are possible.

Since, as has been shown, higher signal power at the knock sensor at the engine position can be detected at individual operating points at selected frequencies, filtering by means of an adaptive band pass is used. For example, this band pass adapts to the expected turbocharger rotational speed by means of a model. Similarly to an order analysis, a section that corresponds to a range around the first order and in which an unbalance manifests in the form of an increase in spectral power density can in this case be filtered out of the spectrum. Higher orders are also suitable.

Since the ATL shaft rotational speed signal in the specific example is not present as a measured value, the determination is carried out as already mentioned via a virtual sensor. A virtual sensor means, in particular, that physical measured variables provide information on a non-directly measurable variable. Variables measured in the air system are used here as input data for ascertaining the theoretical rotational speed. A rotational speed estimation can then be performed on the basis of a compressor map.

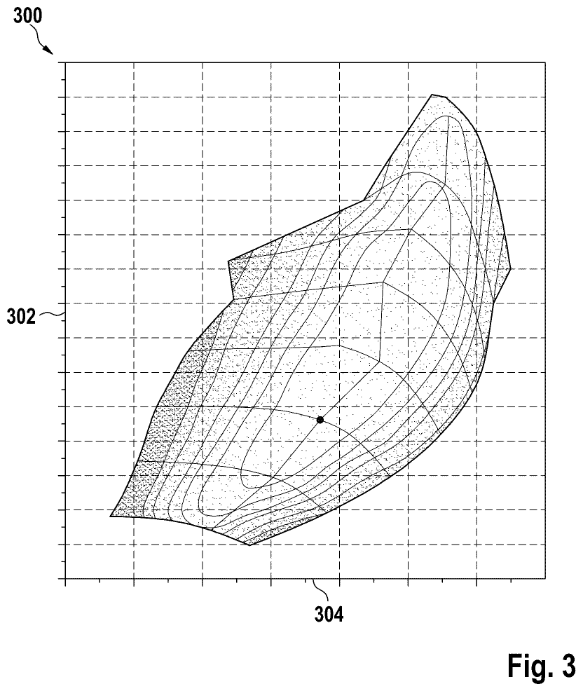

In this respect, FIG. 3 shows, by way of example, a compressor map 300, which is entered in a diagram in which a compressor pressure ratio 302 is plotted over a compressor mass flow 304. An efficiency of the compressor (not relevant here) as well as lines of equal rotational speeds over the variables of the compressor pressure ratio (ordinate) and of the compressor mass flow (abscissa) are thus plotted. From a pair of values consisting of the compressor pressure ratio and the compressor mass flow, an expected exhaust turbocharger rotational speed can be estimated by interpolation.

Since a continuous prediction of the expected rotational frequency is to be ensured as a function of the operating point, the measurement points derived from the characteristic map are estimated, for example, by regression. As this estimate is subject to some uncertainty, an adaptive band pass including a tolerance band around the expected ATL rotational frequency is used in the present case. The pressure ratio via the compressor as well as the mass air flow via the throttle valve are used as input variables for the rotational speed regression model.

For example, a Gaussian process is used as the regression model. This process provides the advantage of flexible function approximation so that the choice of suitable polynomials, which describe the functional relationship in linear models, is eliminated.

The output variable here is a band-pass-filtered signal, the limits of which represent the tolerance band of the expected ATL rotational frequency and +/−150 Hz. It is thus a rotational speed range. However, other bandwidths are also possible.

In a step 220, signal information 222 is provided via one or more signals, e.g., control unit signals, present during operation of the exhaust turbocharger (e.g., the combustion engine or the entire vehicle is also operated). In a step 224,
one or more operating point ranges 226 of the exhaust turbocharger in which the anomaly is to be expected, i.e., will be visible or identifiable in the signal, are determined based thereon.

In a step 230, a filtered sound signal 232 is determined from the sound signal and based on the rotational speed range and the one or more operating point ranges.

In particular, a visibility classification is thus carried out. Since the tonal increase as a result of the anomaly or damage occurs only at very few operating points (between 1% and 3% of all time fractions, as has been shown) in comparison to the rest of the cycle, pre-filtering of the operating point ranges in which an analysis is to be carried out is useful. If this pre-filtering does not take place, there is the risk that the tonal components that are caused by the damage do not have any statistically significant differences due to the amount of data in a distribution analysis.

For this purpose, a random forest classifier can be trained, for example, in advance in a supervised learning process and then, during use, marks corresponding operating points at which a tonal increase is to be expected in the event of damage. Such training may, for example, be carried out on a suitable computer.

Once trained, the visibility classifier no longer requires adjustment for subsequent measurements or further data that the method analyzes. Accordingly, it is also transferable between vehicles (of the same type) under otherwise the same conditions. The visibility classification may also be adopted in a simplified form through expert knowledge and experience-based rules (e.g., if it is known that turbocharger damage always becomes noticeable at high load points due to whistling).

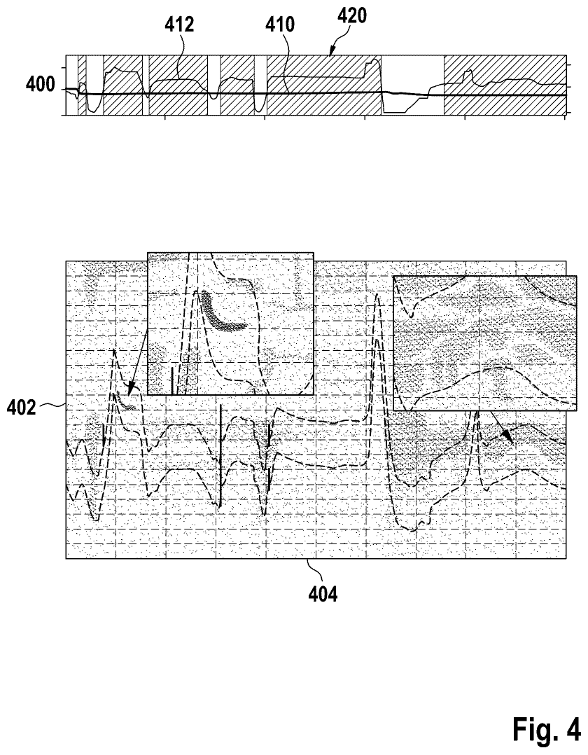

In this respect, a rotational speed and a torque 400 (both variables on one axle) as well as a frequency 402 are plotted over a time 404 in two diagrams in FIG. 4. The upper diagram shows the rotational speed 410 of the engine or of the combustion engine (not of the ATL) and the torque 412 of the engine (without anti-jerk intervention, minus an internal moment); the lower diagram shows associated frequencies in the sound signal of the knock sensor on the engine block.

The upper diagram shows such operating points shaded and, by way of example, denoted once by 420.

The upper illustration or the upper diagram shows the engine variables as context information in which identification of the exhaust turbocharger damage may take place (e.g., at higher engine torques). The shaded ranges are the ranges that the visibility classifier identified in the cycle segment (particularly often here). In addition to the two variables shown, which is only used here for explanation by way of example, further or different input variables may also be used by the visibility classifier for such an assessment.

The detail sections below or in the lower diagram show the ranges where the tonal components are particularly distinct. A color-related change (generally in color in practice, here a change in the density of representation) indicates a higher power density between the two band-pass limits (here the dashed lines).

A random forest represents a model ensemble of decision trees and can be used for classification or regression. One advantage of using a model ensemble is the increase in accuracy in comparison to a single model. In the case of the classification task, each decision tree votes for one class, wherein the final decision corresponds to the modal value of the decision of all trees (e.g., “visibility of the 1st ATL order possible in the event of damage” or “visibility of the 1st ATL order not possible, even in the event of damage”).

However, this is merely an example here for explaining that and how relevant operating point ranges can again be identified in an automated manner. Other classifier models are also possible.

The instantaneous values of the control unit signals in particular serve as input data for the classifier. The term “instantaneous value” describes that the timestamp of the control unit signals should be equal to the mean point in time of the ascertained spectrum of the knock sensor signals (sound signals). Since the sampling rates may differ, this process is in particular carried out via a timestamp comparison. For the spectrogram shown in the lower diagram in FIG. 4, the power spectrum is formed for individual time segments and the classifier decides whether the spectra are included in the further analysis or not.

A basic idea of this learning process is that, in the event of damage, the operating point ranges in which a tonal increase occurs in the band pass described above will be filtered out thereby. In the undamaged state, the ranges are also filtered, but no tonal increase is to be expected in this case.

Five examples of control unit signals that may be used to assess the potential visibility of a tonal increase are: a corrected mass flow bank 1 (bank 1 here is a side or bank of a V-engine), a relative fuel mass, an actual torque without anti-jerk intervention minus an internal moment, a vehicle velocity, and an upper-limited reference level.

However, other control unit signals may, of course, also be suitable for the classification.

In step 240, a measure 242 of a tone stability of the filtered sound signal is determined. In particular, the measure of the tone stability of the filtered sound signal is based on a complimentary value of a spectral flatness of the filtered sound signal that is aggregated into a density distribution or frequency distribution over multiple points in time.

Thus, an indicator is formed in particular. In order to be able to quantify the tone stability of the signal in the band-pass-filtered signal (filtered sound signal) and to automate the process of identification, the measure of the spectral flatness (SF) ascertained from the power spectrum can be used. Further indicators or other measures of the tone stability are also possible, as mentioned below. This measure represents the ratio between the geometric mean and the arithmetic mean and thus serves as an indicator of how tone-stable the signal is in the extracted band pass (cf. also signal-to-noise ratio). Since, by definition, the spectral flatness assumes the value 1 in the case of pure noise and the value 0 in the case of pure tone stability, the complement is formed (1-SF) for reasons of interpretability (increasing damage, increasing value). The formula for the spectral flatness is:

$$S F = \frac{exp ( \frac{1}{N} {\sum }_{n = 0}^{N - 1} ln x ( n ) )}{\frac{1}{N} {\sum }_{n = 0}^{N - 1} x ( n )}$$

Here, x(n) denotes a value (magnitude) of a bin number n in N bins. In order to make the method for damage identification on the basis of the spectral flatness more robust, the ascertained complementary values of the spectral flatness can be aggregated into a density distribution over multiple points in time (over a complete measurement cycle in the specific example). This distribution describes how often tonal components occur in a particular time interval.

If an unbalance occurs, tonal components accumulate and the indicator value increases, while noise is more likely to occur in the undamaged state, i.e., when no tonal components are present, and smaller indicator values are thus to be expected.

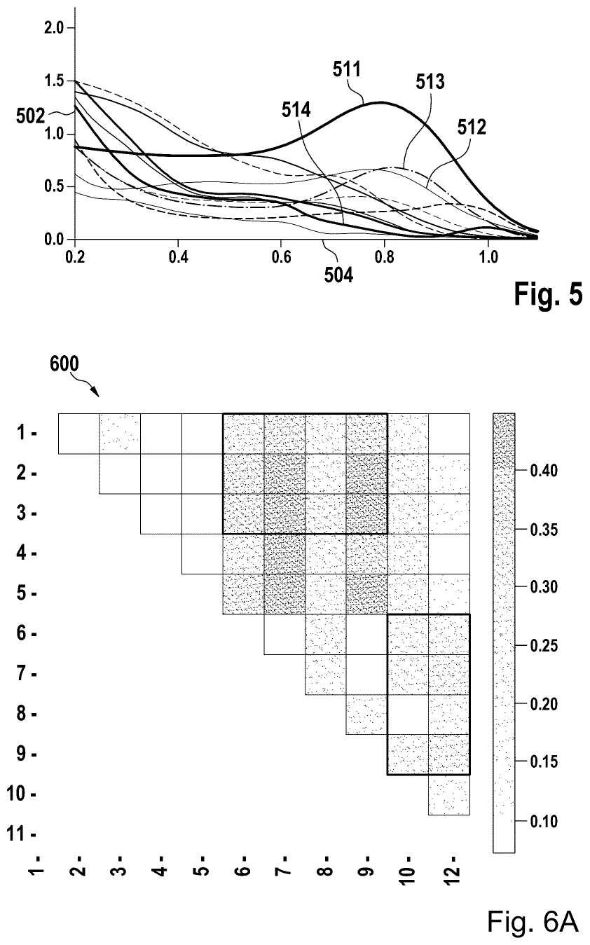

In this respect, a probability density 502 is plotted over a tone stability indicator (1-SF) 504 in a diagram in FIG. 5. Values less than 0.2 are not shown due to the range of pure noise that is not relevant for the evaluation. Multiple curves are shown.

The curve 511 is an example which clearly shows (accumulation in the range of 0.8) the described effect of the tone stability caused by the anomaly. Specifically, the exhaust turbocharger underlying the curve 511 is one in which the compressor blade has significant material removal. This applies analogously to the curve 512; the effect is also visible in the curve 513, wherein at least minor material removal was present there.

In a step 244, a deviation 246 is then determined between the measure 242 and a measure of the tone stability of a filtered comparison sound signal. While the measure 242, i.e., the measure of the tone stability of the filtered sound signal, may correspond to the curve 511, the measure 246, i.e., the measure of the tone stability of the filtered comparison sound signal, corresponds, for example, to the curve 514; this is because the curve 514 is, for example, for an exhaust gas turbocharger without known anomaly. As mentioned, the Kolmogorov-Smirnov test can be used for this purpose.

In particular, a distribution formation and the Kolmogorov-Smirnov test are thus carried out. In order to be able to quantify the difference in the distributions, the Kolmogorov-Smirnov test (KS test) can be used. The Kolmogorov-Smirnov Test is typically used to check whether two variables (here the variable from the measurement cycles without anomaly, e.g., curve 514, and from a measurement cycle with a damage manifestation, e.g., curve 511) follow the same distribution function. The KS test uses the empirical distribution functions for this purpose. The visibility classifier here further ensures that the operating point ranges to be evaluated are similar so that the influence of different load ranges remains as small as possible.

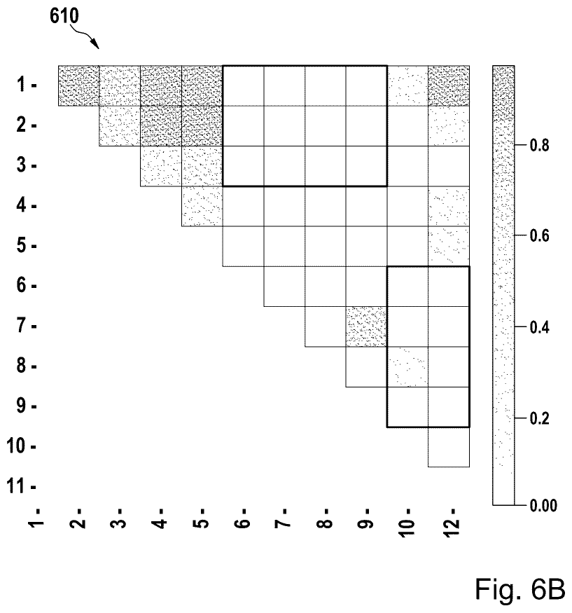

FIGS. 6A, 6B show exemplary results of the KS test for measurements 1 to 10 and 12 (number 11 was not assigned in the underlying example) in a pairwise comparison. The Kolmogorov-Smirnov test provides two main results: the KS statistic 600 in FIG. 6A and the p-value 610 in FIG. 6B.

The KS statistic is a measure of the maximum deviation between the distribution functions of two samples and can be between 0 and 1. A value of 0 indicates that the distribution functions match perfectly, while a value of 1 indicates a maximum deviation. The greater the KS statistic, the greater the deviation between the two functions.

The p-value is a statistical measure that indicates how well the data match the null hypothesis. A small p-value indicates that the distributions of two measurements are different, while a large p-value indicates that the distributions of two measurements match. Generally, a significance level (e.g., 0.05) is set and, if the p-value is less than this significance level, the null hypothesis is rejected, and it is assumed that the data do not originate from the same distribution.

The marked areas (framed boxes) represent the values of particular interest since the distribution of the tone stability indicator between the measurements from the class “no anomaly” and the class “anomaly” are compared here. It can be seen that, from minor damage manifestations (e.g., measurement 6), the KS test provides a larger KS statistic and a p-value less than 0.05, which indicates that there are statistically significant differences in the distributions.

For explanation, it is mentioned that measurements 1 to 4 show a good state, measurements 5 and 6 show a minor damage manifestation, measurement 7 shows a medium damage manifestation, measurements 8 and 9 show a major damage manifestation, and measurements 10 and 12 show a good state of a further specimen of a turbocharger.

The results show that the anomalies or, in the specific case, compressor blade damage can be identified by means of the method.

In a step 250, based on the deviation, it is then determined whether an anomaly 252 of the component is present and/or to what extent the anomaly of the component is present.

In addition to the specific example as explained above, further modifications and possibilities for improvement may also be provided. It should be noted at this point that various parameters in the process, in particular the number of data points used to calculate the power spectrum, can influence the result. From the point of view of the identification method, it must be taken into account for the number of data points that the frequency resolution in the spectrum should be high enough to be able to map the tonal component (uncertainty principle/fundamental law of information technology). From a point of view of a control unit, an available buffer for measured KS signal values typically represents a limiting influence.

For a possible development of the method, the indicator described above can be extended by additional features in the adaptive band pass. These includes, for example, a minimum value of the values in the band pass (Min), a maximum value of the values in the band pass (Max), a range of the values in the band pass (Max-Min), an arithmetic mean of the values in the band pass (Mean), a standard deviation of the values in the band pass (Std), or other, different ratios (Max/Std, Max/Mean, Max/Min, etc.).

In addition, the rotational speed model may be further improved by means of additional measurement points or the empirically ascertained values. A greater proportion of acquired data in the damaged state furthermore helps to improve the visibility classifier and to increase its robustness. To this end, as many influencing factors of the operating behavior as possible must, for example, be included (different temperatures, underlying surfaces, etc.).

For vehicles with the ATL rotational speed sensor installed, the method may also be modified, as already mentioned, to a form of the order analysis that normalizes the different rotational speeds to the shaft orders and there evaluates the tone stability in a defined window.

Furthermore, the procedure for the band pass may, for example, also be improved with automated feature generation (e.g., by a convolutional neural network) and associated methods from the area of computer vision (e.g., image classification) in order to make early damage identification possible. A generalist approach would thus be provided, which is suitable for further damages and their detection by means of a knock sensor, for example.

Further possible variants and additions are, for example, other windowing (rectangle, Hanning, Blackman, etc.) for ascertaining the power spectrum, or different scaling (dB and linear). An airborne sound signal or a liquid-borne sound signal may also be used instead of the structure-borne sound signal. Also possible is the reversal of the method for decreasing tonal components. In addition to the 1st rotational speed order, other rotational speed orders or combinations thereof may also be used. The method may also be used for non-integer multiples of the fundamental frequency (e.g., for modulated frequencies, sidebands). In addition to acceleration, the velocity or the position may also be measured or used (e.g., in the case of the control unit signals). The measurement of the vibrations may also be carried out by optical methods (and the corresponding sensor) instead of a structure-borne sound sensor or knock sensor. Instead of the statistical test, other methods for anomaly identification may also be used. These include, for example, distance-based, density-based, and angle-based methods.

Since the proposed method does not use any path tracking algorithms, it also works if the signature of the ATL is only seen sporadically, acyclically, i.e., with interruptions of varying lengths.

Since the proposed method is modular, it may be used in whole or in part. For example, the visibility classifier or the learned band pass limits for the ATL search function may also be used in isolation if the boundary conditions change.

Since the tonal components only occur sporadically, the visibility classifier makes it possible to classify the data points reliably with only a few labeled data points.

The proposed method works robustly with different turbochargers. Turbocharger-specific knowledge available during the development process is used by the method and can be incorporated into the approach. If the compressor map, a turbocharger rotational speed sensor, or an existing rotational speed model is available, the first process step can be implemented with little effort even without additional data acquisition.

For training data of the proposed method, apart from the visibility classifier, only data of the undamaged turbocharger are needed, for example. This is generally given at the beginning of the product life cycle so that the method can be specifically adapted to any turbocharger without much additional effort. This property significantly facilitates data acquisition and data labeling in the field in comparison to a supervised learning method.

The proposed method may potentially also identify other damage mechanisms resulting in an unbalance of the shaft. This also extends to previously unknown patterns in the data.

The proposed method makes scalability and adaptability of the algorithm possible. For example, if the characteristic of the operating states changes or a garage is visited and a new turbocharger is installed in the vehicle, continuous adaptation or retraining of the algorithm is possible without additional annotation of the data and with changing circumstances. Reconfiguration or additional data acquisition is not required. The one-dimensional, physically explainable indicators of tone stability and the direct connection to the turbocharger rotational speed and to the customer's sense of hearing (so-called turbocharger whistling) provide ease of interpretation, improved interpretability and causality. The proposed method may also be used if many interference variables influence the damage indicator (e.g., load variables) and if other interference variables mask the useful signal (e.g., combustion noises).

1-12. (canceled)

13. A method for identifying an anomaly in a component of a technical system, wherein the component performs a periodic movement during operation of the technical system, the method comprising the following steps:
providing a sound signal, wherein the sound signal has been detected, during operation of the technical system, using a sensor of the technical system or of a further technical system mechanically connected to the technical system;
determining or providing a rotational speed range in which a rotational speed of the component lies during operation of the technical system;
determining or providing one or more operating point ranges of the technical system in which the anomaly is to be expected;
determining a filtered sound signal from the sound signal and based on the rotational speed range and the one or more operating point ranges;
determining a measure of a tone stability of the filtered sound signal; and
determining, based on the measure of the tone stability: (i) whether an anomaly of the component is present and/or (ii) to what extent the anomaly of the component is present.

14. The method according to claim 13, wherein the measure of the tone stability of the filtered sound signal is based on a complimentary value of a spectral flatness of the filtered sound signal that is aggregated into a density distribution or frequency distribution over multiple points in time.

15. The method according to claim 13, further comprising:
determining a deviation between the measure of the tone stability of the filtered sound signal and a measure of the tone stability of a filtered comparison sound signal;
wherein, based on the deviation, it is determined whether the anomaly of the component is present and/or to what extent the anomaly of the component is present.

16. The method according to claim 15, wherein the deviation is determined based on a Kolmogorov-Smirnov test.

17. The method according to claim 13, furthermore comprising:
providing operating variable information on one or more operating variables of the technical system during operation of the technical system;
wherein the rotational speed range is determined based on the operating variable information.

18. The method according to claim 13, furthermore comprising:
providing signal information via one or more signals present during operation of the technical system;
wherein the one or more operating point ranges of the technical system in which the anomaly is to be expected are determined based on the signal information.

19. The method according to claim 13, wherein the one or more operating point ranges of the technical system in which the anomaly is to be expected are determined using a machine learning model.

20. The method according to claim 13, wherein the technical system is an exhaust turbocharger, and the component of the technical system is a turbine wheel of the exhaust turbocharger or a compressor wheel of the exhaust turbocharger.

21. The method according to claim 13, wherein the sensor is a structure-borne sound sensor including a knock sensor.

22. A computing unit configured to identify an anomaly in a component of a technical system, wherein the component performs a periodic movement during operation of the technical system, the computing unit configured to:
provide a sound signal, wherein the sound signal has been detected, during operation of the technical system, using a sensor of the technical system or of a further technical system mechanically connected to the technical system;
determine or providing a rotational speed range in which a rotational speed of the component lies during operation of the technical system;
determine or providing one or more operating point ranges of the technical system in which the anomaly is to be expected;
determine a filtered sound signal from the sound signal and based on the rotational speed range and the one or more operating point ranges;
determine a measure of a tone stability of the filtered sound signal; and
determine, based on the measure of the tone stability: (i) whether an anomaly of the component is present and/or (ii) to what extent the anomaly of the component is present.

23. A non-transitory machine-readable storage medium on which is stored a computer program for identifying an anomaly in a component of a technical system, wherein the component performs a periodic movement during operation of the technical system, the computer program, when executed by a computing unit, causing the computing unit to perform the following steps:
providing a sound signal, wherein the sound signal has been detected, during operation of the technical system, using a sensor of the technical system or of a further technical system mechanically connected to the technical system;
determining or providing a rotational speed range in which a rotational speed of the component lies during operation of the technical system;
determining or providing one or more operating point ranges of the technical system in which the anomaly is to be expected;
determining a filtered sound signal from the sound signal and based on the rotational speed range and the one or more operating point ranges;
determining a measure of a tone stability of the filtered sound signal; and
determining, based on the measure of the tone stability: (i) whether an anomaly of the component is present and/or (ii) to what extent the anomaly of the component is present.
